(19) United States
(12) Patent Application Publication
(10) Pub. No.: US 2010/0230242 A1
(43) Pub. Date: Sep. 16, 2010

(54) SYSTEMS AND METHOD FOR SCANNING A CONTINUOUS STREAM OF OBJECTS

(76) Inventors: Samit Kumar Basu, Fremont, CA (US); Pierfrancesco Landolfi, Palo Alto, CA (US); Sussan Pourjavid-Granfors, Sunnyvale, CA (US); Eugene Alex Ingerman, San Francisco, CA (US); Jian Gao, San Jose, CA (US); Mikhail Kourinny, Milpitas, CA (US); Francois Robert Gaultier, Oakland, CA (US)

Correspondence Address: PATRICK W. RASCHE (22697);ARMSTRONG TEASDALE LLP, 7700 Forsyth Boulevard, Suite 1800, St. Louis, MO, 63105, US

(21) Appl. No.: 12/401,907

(22) Filed: Mar. 11, 2009

(51) Int. Cl. B65G 47/00; G01J 5/00

(52) U.S. Cl. 198/502.2; 250/338.1

(57) ABSTRACT

A method for scanning a stream of objects includes conveying the stream of objects through a scanning system using a conveyor, marking a leading edge position of an object within the stream of objects with respect to a first known distance between a sensor and a start of a scan range, and recording data associated with the object when the leading edge position reaches the start of the scan range. The method also includes marking a trailing edge position of the object with respect to a second known distance between the sensor and an end of the scan range, halting recording of the data when the trailing edge reaches the end of the scan range, and generating a three-dimensional image of the object based on the recorded data.

### BACKGROUND OF THE INVENTION

1. Field of the Invention

The embodiments described herein relate generally to scanning a stream of objects and, more particularly, to systems and methods for scanning a stream of objects based on a position of a leading edge and a trailing edge of each object.

2. Description of the Related Art

At least some known scanning systems use a computer tomography (CT) system to scan a stream of objects. At least some known CT systems select a set of slice locations based on a single projection image of an object. The slice locations are then used to position an object for scanning in a particular plane. The resulting scan data is used to generate a two-dimensional image at the prescribed slice location. However, such systems create only two-dimensional images. In order to generate a three-dimensional image of an object, a plurality of two-dimensional images must be captured and processed, which demands a high degree of processing power and/or time. Such systems must process data continuously and are likely to fall behind the conveyance of the objects through the system.

Other known scanning systems use continuous flow three-dimensional helical scanning. However, such systems reconstruct a continuous stream of images, and then use inspection software to partition the image stream into discrete objects for inspection. Such systems require continuous data processing and, similar to the scanning systems described above, are likely to fall behind the conveyance of the objects through the system. Moreover, the CT system and the inspection software may disagree about the points of segmentation of the image stream into separate objects.

Accordingly, there is a need for a scanning system that can partition scan data into blocks that are each associated with an object by determining a position of each of a leading edge and a trailing edge of each object, and that can generate an image of each object based on the respective data block.

### BRIEF DESCRIPTION OF THE INVENTION

In one aspect, a method for scanning a stream of objects is provided. The method includes conveying the stream of objects through a scanning system using a conveyor, marking a leading edge position of an object with respect to a first known distance between a sensor and a start of a scan range, and recording data associated with the object when the leading edge position reaches the start of the scan range. The method also includes marking a trailing edge position of the object with respect to a second known distance between the sensor and an end of the scan range, halting recording of the data when the trailing edge reaches the end of the scan range, and generating a three-dimensional image of the object based on the recorded data.

In another aspect, a scanning system is provided that includes a conveyor configured to convey a stream of objects through said scanning system, a conveyor controller in communication with the conveyor, a scanner, a scan controller in communication with the scanner, and a control system in communication with the conveyor controller and the scan controller. The control system marks a leading edge position of an object, and performs a scan of the object to acquire data using the scan controller when the leading edge position reaches a start of a scan range. The control system then marks a trailing edge position of the object, issues a halt command to the scan controller in order to stop the scan when the trailing edge position reaches an end of the scan range, and generates a three-dimensional image of the object based on the data acquired during the scan.

In another aspect, a scanning system is provided that includes a conveyor configured to convey a stream of objects through said scanning system, a conveyor controller operatively coupled to the conveyor, a scanner, and a scan controller operatively coupled to the scanner. The scanning system also includes a motion controller communicatively coupled to a sensor, wherein the motion controller marks a leading edge position of an object when the leading edge of the object breaks a plane defined by a light beam emitted by said sensor, and marks a trailing edge position of the object when the trailing edge of the object breaks the plane defined by the light beam emitted by said sensor. The scanning system also includes an acquisition controller coupled to the motion controller and to the scan controller. The acquisition controller performs a scan of the object to acquire data using the scan controller when the leading edge position reaches a start of a scan range, issues a halt command to the scan controller in order to stop the scan when the trailing edge position reaches an end of the scan range, and generates a three-dimensional image of the object based on data acquired during the scan.

The embodiments described herein enable scanning of a stream of objects and reconstruction of an image of an object within the stream based on a detection of a leading edge and a trailing edge of each object, and the relationship between the leading and trailing edges to respective known positions of a conveyor.

### BRIEF DESCRIPTION OF THE DRAWINGS

FIGS. 1-3 show exemplary embodiments of the systems and method described herein.

FIG. 1 is a schematic block diagram of an exemplary scanning system.

FIG. 2 is a schematic block diagram of another exemplary scanning system.

FIG. 3 is a flowchart illustrating an exemplary method of performing a scan using the scanning systems shown in FIGS. 1 and 2.

### DETAILED DESCRIPTION OF THE INVENTION

In order to accurately inspect and reconstruct an image of an object within an imaging section of a scanning system based on detection of a leading edge of the object and a trailing edge of the object, a method of scanning the object includes detecting the leading and trailing edges of the object using a sensor and marking a position of each of the leading and trailing edges within a data stream. When the marked leading edge position reaches a start of a scan range, a scan is started in which data related to the object is recorded. The scan is halted when the marked trailing edge position reaches an end of the scan range, and an image of the object is generated based on the recorded data. Such a method may be implemented using any suitable scanning system.

A first implementation includes a motion controller that detects a leading edge and a trailing edge and marks a respective leading edge position and a trailing edge position. A detector controller receives conveyor position data and compares the marked leading and trailing edge positions with the conveyor position data such that an acquisition controller begins a scan of the object when the marked leading edge position matches reaches a start of a scan range and stops the scan when the marked trailing edge position reaches an end of the scan range.

A second implementation includes a motion controller that detects a leading edge and a trailing edge and marks a respective leading edge position and a trailing edge position. A detector controller receives conveyor position data, and an acquisition controller compares the marked leading and trailing edge positions with the conveyor position data such that the acquisition controller begins a scan of the object when the marked leading edge position reaches a start of a scan range and stops the scan when the marked trailing edge position reaches an end of the scan range.

A third implementation includes a motion controller that detects the leading edge and the trailing edge and marks the leading edge position and the trailing edge position. An acquisition controller receives conveyor position data, and compares the marked leading and trailing edge positions with the conveyor position data such that the acquisition controller begins a scan of the object when the marked leading edge position reaches a start of a scan range and stops the scan when the marked trailing edge position reaches an end of the scan range.

As used herein, the phrase “reconstructing an image” is not intended to exclude embodiments in which data representing an image is generated but a viewable image is not. Therefore, as used herein the term “image” broadly refers to both viewable images and data representing a viewable image. However, many embodiments generate (or are configured to generate) at least one viewable image. Additionally, although described in detail in a CT inspection setting, it is contemplated that the benefits accrue to all imaging modalities including, for example, ultrasound, Magnetic Resonance Imaging (MRI), Electron Beam CT (EBCT), Positron Emission Tomography (PET), Single Photon Emission Computed Tomography (SPECT), and in both non-medical settings and medical settings. Further, as used herein, “a scan” refers to a continuous scan that begins when a first object of a stream of objects enters a scanning system and ends when a last object of the stream of objects exits the scanning system.

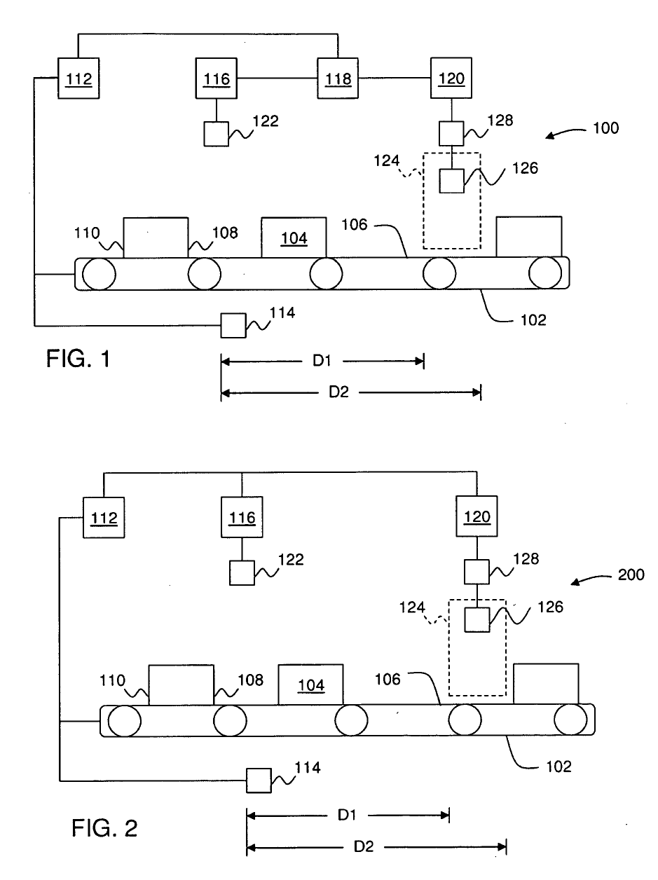

FIG. 1 is a schematic block diagram of a first exemplary scanning system 100. In the first exemplary embodiment, scanning system 100 includes a conveyor 102 that conveys a stream of objects including as object 104 through scanning system 100. During its conveyance, object 104 is positioned on a surface 106 of conveyor 102. Object 104 includes a leading edge 108 and a trailing edge 110. Conveyor 102 is controlled by a conveyor controller 112. Conveyor controller 112 may control variables such as a start of movement of conveyor 102, a stop of movement of conveyor 102, a velocity at which conveyor 102 moves, and/or an acceleration of conveyor 102 when movement is started. However, it should be understood by one of ordinary skill in the art that conveyor controller 112 may control any operational aspect of conveyor 102. In addition, an encoder 114 continuously updates a position of conveyor 102 and transmits encoder pulses related to the position to conveyor controller 112. For example, encoder 114 may determine the position of conveyor 102 based on a distance traveled by conveyor 102 by generating one or more pulse signals for each measure of distance, such as 1.0 centimeter (cm), traveled by conveyor 102. Moreover, in the first exemplary embodiment, scanning system 100 includes a motion controller 116, a detector controller 118, and an acquisition controller 120.

In the first exemplary embodiment, motion controller 116 is coupled to a sensor 122 that detects leading edge 108 and trailing edge 110 of object 104. In the first exemplary embodiment, sensor 122 is an infrared (IR) sensor. In one embodiment, sensor 122 is a vertical sensor array, or light curtain, that includes a plurality of IR transmitters and an opposing plurality of IR receivers, and is oriented in a first plane, such as a vertical plane or an approximately vertical plane. The first plane is perpendicular to a plane defined by surface 106 of conveyor 102. Sensor 122 detects leading edge 108 and trailing edge 110 as object 104 passes sensor 122. In an alternative embodiment, sensor 122 is a point sensor that projects an IR beam that is oriented in a second plane perpendicular to the first plane. As such, the second plane is a horizontal plane, or an approximately horizontal plane, that is approximately parallel to surface 106. Sensor 122 projects an IR beam across surface 106 such that, when object 104 breaks the IR beam, thereby preventing the IR beam from being received by a receiver positioned opposite sensor 122, object 104 is registered by sensor 122 as having crossed a particular marker point. In the first exemplary embodiment, motion controller 116 monitors sensor 122 in order to detect when leading edge 108 and/or trailing edge 110 has crossed the marker point. Motion controller 116 marks a position of leading edge 108 in a data stream with respect to a first known distance, D1, between sensor 122 and a start of a scan range 124. Moreover, motion controller 116 marks a position of trailing edge 110 in the data stream with respect to a second known distance, D2, between sensor 122 and an end of scan range 124. Motion controller 116 then transmits the marked position of each of leading edge 108 and trailing edge 110 within the data stream to detector controller 118. In one embodiment, motion controller 116 adjusts the marked position of each of leading edge 108 and trailing edge 110 to allow for a desired amount of space between successive object 104 in the stream of objects. Moreover, in one embodiment, encoder 114 transmits encoder pulses related to the position to conveyor controller 112 and motion controller 116 in order to maintain a synchronized position of object 104.

In the first exemplary embodiment, detector controller 118 is communicatively coupled to conveyor controller 112 and motion controller 116. Detector controller 118 receives, such as continuously receives, data related to a position of conveyor 102 from conveyor controller 112. Moreover, detector controller 118 receives the marked positions of each of leading edge 108 and trailing edge 110 from motion controller 116. Detector controller 118 compares the conveyor position data received from conveyor controller 112 to the marked positions of each of leading edge 108 and trailing edge 110. When the conveyor position data matches the marked position of leading edge 108, detector controller 118 transmits a signal to acquisition controller 120. Acquisition controller 120 then begins a scan of object 104 using a scanner 126 controlled by a scan controller 128. More specifically, when the conveyor position data matches the marked position of leading edge 108, detector controller 118 generates a flag within a continuous data stream that is transmitted by detector controller 118 to acquisition controller 120. The presence of the flag in the data stream indicates to acquisition controller 120 that object 104 has entered a scan range 124. When acquisition controller 120 senses the flag, acquisition controller 120 signals scan controller 128 to start a scan using scanner 126. When the position data matches the marked position of trailing edge 110, detector controller 118 removes the flag from the data stream. The removal of the flag from the data stream indicates to acquisition controller 120 that object 104 has left scan range 124. As such, when acquisition controller 120 senses the removal of the flag, acquisition controller 120 signals scan controller 128 to stop the scan of object 104. After the scan is completed, acquisition controller 120 generates an image of object 104. Specifically, acquisition controller 120 processes the data generated by the scan of object 104 in order to generate a three-dimensional image of object 104 and its contents. It should be understood to one of ordinary skill in the art that acquisition controller 120 may instead generate a two-dimensional image of object 104 and its contents based on the data generated by the scan of object 104.

In an alternative embodiment of scanning system 100, detector controller 118 is communicatively coupled only to conveyor controller 112, and acquisition controller 120 is communicatively coupled to both motion controller 116 and detector controller 118. Detector controller 118 receives, such as continuously receives, data related to a position of conveyor 102 from conveyor controller 112 as determined by encoder 114. Detector controller 118 then transmits the conveyor position data to acquisition controller 120. In addition to receiving the conveyor position data from detector controller 118, acquisition controller 120 receives the marked positions of each of leading edge 108 and trailing edge 110 from motion controller 116. Acquisition controller 120 compares the conveyor position data received from detector controller 118 to the marked positions of each of leading edge 108 and trailing edge 110. When the conveyor position data matches the marked position of leading edge 108, acquisition controller 120 signals scan controller 128 to start a scan of object 104 using scanner 126. When the position data matches the marked position of trailing edge 110, acquisition controller 120 signals scan controller 128 to stop the scan of object 104. After the scan is completed, acquisition controller 120 generates an image of object 104. Specifically, acquisition controller 120 processes the data generated by the scan of object 104 in order to generate a three-dimensional image of object 104 and its contents.

FIG. 2 is a schematic block diagram of a second exemplary scanning system 200. Components in scanning system 200 that are identical to components of scanning system 100 (shown in FIG. 1) are identified in FIG. 2 using the same reference numerals used in FIG. 1. In the second exemplary embodiment, conveyor 102 conveys a stream of objects including object 104 through scanning system 200. During its conveyance, object 104 is positioned on surface 106 of conveyor 102. Object 104 includes leading edge 108 and trailing edge 110. Conveyor 102 is controlled by conveyor controller 112.

Moreover, in the second exemplary embodiment, motion controller 116 is coupled to sensor 122 that detects leading edge 108 and trailing edge 110 of object 104. Similar to scanning system 100 described above, sensor 122 is an infrared (IR) sensor. Motion controller 116 marks a position of leading edge 108 in a data stream with respect to first distance, D1, between sensor 122 and a start of scan rage 124. Moreover, motion controller 116 marks a position of trailing edge 110 in the data stream with respect to second distance, D2, between sensor 122 and an end of scan range 124. In one embodiment, motion detector 114 adjusts the marked position of each of leading edge 108 and trailing edge 110 to allow for a desired amount of space between successive objects 104 in the stream of objects. Moreover, in one embodiment, encoder 114 transmits encoder pulses related to the position to conveyor controller 112 and motion controller 116 in order to maintain a synchronized position of object 104.

In the second exemplary embodiment, acquisition controller 120 is communicatively coupled to conveyor controller 112 and motion controller 116. Acquisition controller 120 receives, such as continuously receives, data related to a position of conveyor 102 from conveyor controller 112 as determined by encoder 114. Acquisition controller 120 also receives the marked positions of each of leading edge 108 and trailing edge 110 from motion controller 116. Acquisition controller 120 compares the conveyor position data received from conveyor controller 112 to the marked positions of each of leading edge 108 and trailing edge 110. When the conveyor position data matches the marked position of leading edge 108, acquisition controller 120 signals scan controller 128 to start a scan of object 104 using scanner 126. When the position data matches the marked position of trailing edge 110, acquisition controller 120 signals scan controller 128 to stop the scan of object 104. After the scan is completed, acquisition controller 120 generates an image of object 104. Specifically, acquisition controller 120 processes the data generated by the scan of object 104 in order to generate a three-dimensional image of object 104 and its contents.

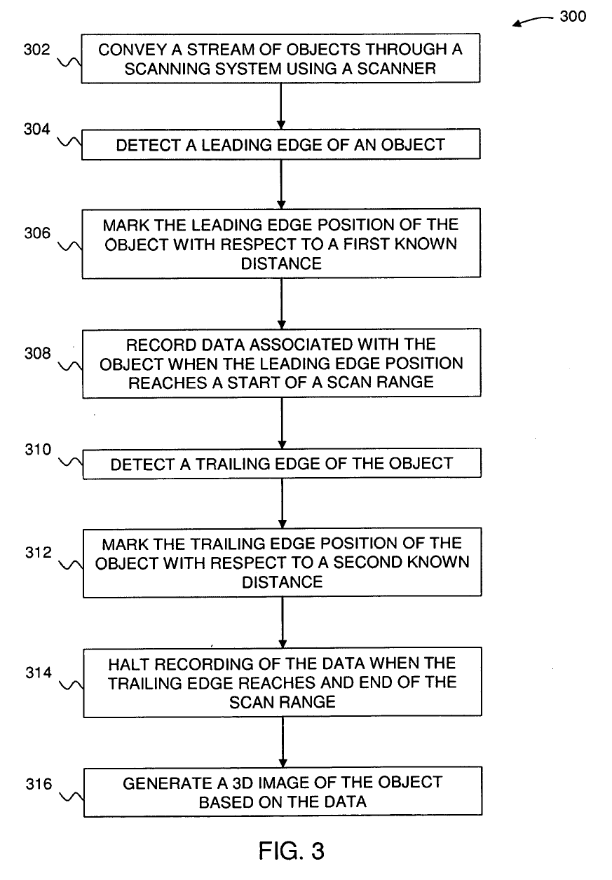

FIG. 3 is a flowchart 300 illustrating an exemplary method for scanning a stream of objects using the scanning systems shown in FIGS. 1 and 2. In the exemplary embodiment, and referring to FIGS. 1 and 2, a stream of objects including object 104 is conveyed 302 through a scanning system using a conveyor, such as conveyor 102. Conveyor 102 may be controlled by conveyor controller 112. For each object 104, leading edge 108 is detected 304 using sensor 122. In the exemplary embodiment, sensor 122 is an IR sensor that emits one or more IR light beams. For example, leading edge 108 is detected by sensor 122 when leading edge 108 breaks the one or more IR light beams. Motion controller 116 is coupled to sensor 122, and marks 306 a position of leading edge 108 with respect to first distance, D1, between sensor 122 and a start of scan range 124. In one embodiment, the marked position of leading edge 108 is adjusted by, for example, motion controller 116 in order to compensate for a desired distance between successive objects 104 within the stream of objects.

Moreover, in the exemplary embodiment, when the marked position of leading edge 108 reaches the start of scan range 124, acquisition controller 120 begins recording 308 data associated with object 104. More specifically, in one embodiment, detector controller 118 (shown in FIG. 1) receives conveyor position data from conveyor controller 112 as determined by encoder 114. Moreover, detector controller 118 receives the marked, position of leading edge 108 from motion controller 116. Detector controller 118 compares the marked position of leading edge 108 to continuously received conveyor position data to determine when the marked position of leading edge 108 has reached the start of scan range 124. When the marked position of leading edge 108 has been conveyed the first distance, D1, and reaches the start of scan range 124, detector controller 118 transmits a flag within a data stream to acquisition controller 120. When acquisition controller 120 senses the flag within the data stream, acquisition controller 120 signals scan controller 128 to start a scan of object 104 using scanner 126, and records data generated by the scan. In an alternative embodiment, detector controller 118 receives conveyor position data from conveyor controller 112 and transmits the conveyor position data to acquisition controller 120. Acquisition controller 120 also receives the marked position of leading edge 108 from motion controller 116. Acquisition controller 120 compares the marked position of leading edge 108 to continuously received conveyor position data to determine when the marked position of leading edge 108 has reached the start of scan range 124. When the marked position of leading edge 108 has been conveyed the first distance, D1, acquisition controller 120 signals scan controller 128 start a scan of object 104 using scanner 126 and records data generated by the scan. In another alternative embodiment, acquisition controller 120 receives conveyor position data from conveyor controller 112 and receives the marked position of leading edge 108 from motion controller 116. Acquisition controller 120 compares the marked position of leading edge 108 to the continuously received conveyor position data to determine when the marked position of leading edge 108 reaches the start of scan range 124. When the marked position of leading edge 108 has been conveyed the first distance, D1 and reaches the start of scan range 124, acquisition controller 120 signals scan controller 128 to start a scan of object 104 using scanner 126, and records data generated by the scan.

In the exemplary embodiment, and for each object 104, trailing edge 110 is then detected 310 using sensor 122. Similar to the steps described above with regards to leading edge 108, trailing edge 110 is detected by sensor 122 when trailing edge 110 breaks the one or more IR light beams. Motion controller 116 is coupled to sensor 122, and marks 312 a position of trailing edge 110 with respect to second known distance, D2, between sensor 122 and an end of scan range 124. In one embodiment, the marked position of trailing edge 110 is adjusted by, for example, motion controller 116 in order to compensate for a desired distance between successive objects 104 within the stream of objects.

Moreover, in the exemplary embodiment, when the marked position of trailing edge 110 reaches the end of scan range 124, acquisition controller 120 halts 314 recording of the data associated with object 104. More specifically, in one embodiment, detector controller 118 receives conveyor position data from conveyor controller 112 as determined by encoder 114. Moreover, detector controller 118 receives the marked position of trailing edge 110 from motion controller 116. Detector controller 118 compares the marked position of trailing edge 110 to the continuously received conveyor position data to determine when the marked position of trailing edge 110 reaches the end of scan range 124. When the marked position of trailing edge 110 has been conveyed the second distance, D2, and reaches the end of scan range 124, detector controller 118 stops transmission of the flag within the data stream to acquisition controller 120. When acquisition controller 120 senses that the flag has been removed from the data stream, acquisition controller 120 signals scan controller 128 to stop the scan of object 104, thereby stopping recording of the data generated by the scan. In an alternative embodiment, detector controller 118 receives conveyor position data from conveyor controller 112, as determined by encoder 114, and transmits the conveyor position data to acquisition controller 120. Acquisition controller 120 also receives the marked position of trailing edge 110 from motion controller 116. Acquisition controller 120 compares the marked position of trailing edge 110 to the continuously received conveyor position data to determine when the marked position of trailing edge 110 reaches the end of scan range 124. When the marked position of trailing edge 110 has been conveyed the second distance, D2, and reaches the end of scan range 124, acquisition controller 120 signals scan controller 128 to stop the scan of object 104, thereby stopping recording of the data generated by the scan. In another alternative embodiment, acquisition controller 120 receives conveyor position data from conveyor controller 112, as determined by encoder 114, and receives the marked position of trailing edge 110 from motion controller 116. Acquisition controller 120 compares the marked position of trailing edge 110 to the continuously received conveyor position data to determine when the marked position of trailing edge 110 reaches the end of scan range 124. When the marked position of trailing edge 110 has been conveyed the second distance, D2, and reaches the end of scan range 124, acquisition controller 120 signals scan controller 128 to stop the scan of object 104, thereby stopping recording of the data generated by the scan.

In the exemplary embodiment, acquisition controller 120 processes the recorded data and generates 316 an image, such as a three-dimensional image, of object 104. In some embodiments, the scanning system may include a plurality of acquisition controllers arranged such that each acquisition controller scans a different object and generates an image of the respective object based on the scan.

The above-described embodiments facilitate continuously scanning a stream of objects. More specifically, the embodiments described herein enable a scanning system to generate higher quality images and/or images with higher resolution due to a lower required amount of data processing. The amount of processing is reduced by eliminating data processing and/or image generation during times when an object is not being scanned. More specifically, the embodiments described herein scan an object only when a leading edge of the object reaches a predetermined point and stops the scan when a trailing edge of the object reaches the same predetermined point. Only the interval, which relates to the object itself as well as any desired padding, is processed. Moreover, processing only the actual object enables the scanner to keep pace with the conveyor without requiring frequent stops and starts of the conveyor. Furthermore, generating higher quality images and/or higher resolution images facilitates reducing a number of false alarms generated by the scanner. In addition, tracking the leading and trailing edges of each object enables each object to be tracked through the acquisition processing, which enables a correspondence to be established and/or communicated with an external device, such as a baggage handling system.

A technical effect of the systems and method described herein includes at least one of: (a) conveying a stream of objects through a scanning system; (b) detecting a leading edge of an object using a sensor and marking the leading edge position with respect to a first known distance between a sensor and a start of a scan range; (c) recording data generated by a scan of the object, wherein the scan is started when the leading edge position reaches the start of the scan range; (d) detecting a trailing edge of the object using the sensor and marking the trailing edge position with respect to a second known distance between the sensor and an end of the scan range; (e) halting recording of the data generated by the scan when the trailing edge position reaches the end of the scan range; and (f) generating a three-dimensional image of the object based on the recorded data.

Exemplary embodiments of systems and methods for performing a scan of an object are described above in detail. The systems and method are not limited to the specific embodiments described herein, but rather, components of the systems and/or steps of the method may be utilized independently and separately from other components and/or steps described herein. For exempla, the method may also be used in combination with other scanning systems and methods, and is not limited to practice with the computer tomography systems as described herein. Rather, the exemplary embodiment may be implemented and utilized in connection with many other imaging applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for scanning a stream of objects, said method comprising:
conveying the stream of objects through a scanning system using a conveyor;
marking a leading edge position of an object in the stream of objects with respect to a first known distance between an edge sensor and a start of a scan range;
recording data associated with the object when the leading edge position reaches the start of the scan range;
marking a trailing edge position of the object with respect to a second known distance between the edge sensor and an end of the scan range;
halting recording of the data when the trailing edge reaches the end of the scan range; and
generating a three-dimensional image of the object based on the recorded data.

2. The method of claim 1, wherein marking a leading edge position of an object comprises detecting the leading edge of the object using an infrared (IR) sensor.

3. The method of claim 1, further comprising adjusting the leading edge position based on a desired distance between successive objects in the stream of objects.

4. The method of claim 1, wherein recording data associated with the object comprises:
comparing the leading edge position with conveyor position data that corresponds to the start of the scan range; and
recording the data when the leading edge position reaches the start of the scan range.

5. The method of claim 1, wherein marking a trailing edge position of an object comprises detecting the trailing edge of the object using an infrared (IR) sensor.

6. The method of claim 1, further comprising adjusting the trailing edge position based on a desired distance between successive objects in the stream of objects.

7. The method of claim 1, wherein halting recording of the raw data comprises:
comparing the trailing edge position with conveyor position data that corresponds to the end of the scan range; and
halting recording of the raw data when the trailing edge position reaches the end of the scan range.

8. A scanning system, comprising:
a conveyor configured to convey a stream of objects through said scanning system;
a conveyor controller in communication with said conveyor;
a scanner;
a scan controller in communication with said scanner; and
a control system in communication with said conveyor controller and said scan controller, said control system configured to:
mark a leading edge position of an object in the stream of objects;
perform a scan of the object to acquire data using said scan controller when the leading edge position reaches a start of a scan range;
mark a trailing edge position of the object;
issue a halt command to said scan controller in order to stop the scan when the trailing edge position reaches an end of the scan range; and
generate a three-dimensional image of the object based on the data acquired during the scan.

9. The scanning system of claim 8, wherein said control system comprises a sensor and a motion controller communicatively coupled to said sensor, said motion controller configured to:
detect when the leading edge of the object breaks a plane defined by a light beam emitted by said sensor;
mark the leading edge position;
detect when the trailing edge of the object breaks the plane defined by the light beam emitted by said sensor; and
mark the trailing edge position.

10. The scanning system of claim 9, wherein said motion controller is further configured to adjust at least one of the leading edge position and the trailing edge position based on a desired distance between successive objects in the stream of objects.

11. The scanning system of claim 9, wherein said control system further comprises a detector controller communicatively coupled to said conveyor controller and said motion controller, said detector controller configured to:
receive conveyor position data from said conveyor controller;
receive the leading edge position and the trailing edge position from said motion controller;
compare each of the leading edge position and the trailing edge position with the conveyor position data;
generate a flag when the leading edge position matches a first conveyor position that corresponds to a first distance between said sensor and the start of the scan range; and
remove the flag when the trailing edge position matches a second conveyor position that corresponds to a second distance between said sensor and the end of the scan range.

12. The scanning system of claim 11, wherein said control system further comprises an acquisition controller communicatively coupled to said detector controller and said scan controller, said acquisition controller configured to:
receive the flag from said detector controller;
perform the scan of the object to acquire data using said scan controller when the flag is present;
issue the halt command to said scan controller in order to stop the scan when the flag is removed; and
generate the three-dimensional image of the object based on the data acquired during the scan.

13. The scanning system of claim 9, wherein said control system further comprises a detector controller communicatively coupled to said conveyor controller and said motion controller, said detector controller configured to receive conveyor position data from said conveyor controller.

14. The scanning system of claim 13, wherein said control system further comprises an acquisition controller communicatively coupled to said detector controller and said scan controller, said acquisition controller configured to:
receive conveyor position data from said detector controller;
receive the leading edge position and the trailing edge position from said motion controller;
compare each of the leading edge position and the trailing edge position with the conveyor position data;
perform the scan of the object to acquire data using said scan controller when the leading edge position matches a first conveyor position that corresponds to a first distance between said sensor and the start of the scan range;
issue the halt command to said scan controller in order to stop the scan when the trailing edge position matches a second conveyor position that corresponds to a second distance between said sensor and the end of the scan range; and
generate the three-dimensional image of the object based on the data acquired during the scan.

15. The scanning system of claim 9, wherein said control system further comprises an acquisition controller communicatively coupled to said conveyor controller, said scan controller, and said motion controller, said acquisition controller configured to:
receive conveyor position data from said conveyor controller;
receive the leading edge position and the trailing edge position from said motion controller;
compare each of the leading edge position and the trailing edge position with the conveyor position data;
perform the scan of the object to acquire data using said scan controller when the leading edge position matches a first conveyor position that corresponds to a first distance between said sensor and the start of the scan range;
issue the halt command to said scan controller in order to stop the scan when the trailing edge position matches a second conveyor position that corresponds to a second distance between said sensor and the end of the scan range; and
generate the three-dimensional image of the object based on the data acquired during the scan.

16. A scanning system, comprising:
a conveyor configured to convey a stream of objects through said scanning system;
a conveyor controller operatively coupled to said conveyor;
a scanner;
a scan controller operatively coupled to said scanner;
a motion controller communicatively coupled to a sensor, said motion controller configured to:
mark a leading edge position of an object within the stream of objects when the leading edge of the object breaks a plane defined by a light beam emitted by said sensor;
mark a trailing edge position of the object when the trailing edge of the object breaks the plane defined by the light beam emitted by said sensor; and
an acquisition controller communicatively coupled to said motion controller and operatively coupled to said scan controller, said acquisition controller configured to:
perform a scan of the object to acquire data using said scan controller when the leading edge position reaches a start of a scan range;
issue a halt command to said scan controller in order to stop the scan when the trailing edge position reaches an end of the scan range; and
generate a three-dimensional image of the object based on data acquired during the scan.

17. The scanning system of claim 16, further comprising a detector controller communicatively coupled to said motion controller and said acquisition controller, said detector controller configured to:
receive conveyor position data from said conveyor controller;
receive the leading edge position and the trailing edge position from said motion controller;
compare each of the leading edge position and the trailing edge position with a respective first conveyor position and second conveyor position, the first conveyor position corresponding to a first distance between said sensor and the start of the scan range, the second conveyor position corresponding to a second distance between said sensor and the end of the scan range;
generate a flag when the leading edge position matches the first conveyor position; and
remove the flag when the trailing edge position matches the second conveyor position.

18. The scanning system of claim 17, wherein said acquisition controller is further configured to:
receive the flag from said detector controller;
perform the scan of the object to acquire data using said scan controller when the flag is present;
issue the halt command to said scan controller in order to stop the scan when the flag is removed; and
generate the three-dimensional image of the object based on the data acquired during the scan.

19. The scanning system of claim 16, further comprising a detector controller communicatively coupled to said motion controller and said acquisition controller, said detector controller configured to receive conveyor position data from said conveyor controller, said acquisition controller further configured to:
receive the conveyor position data from said detector controller;
receive the leading edge position and the trailing edge position from said motion controller;
compare each of the leading edge position and the trailing edge position with a respective first conveyor position and second conveyor position, the first conveyor position corresponding to a first distance between said sensor and the start of the scan range, the second conveyor position corresponding to a second distance between said sensor and the end of the scan range;
perform the scan of the object to acquire raw data using said scan controller when the leading edge position matches the first conveyor position;
issue the halt command to said scan controller in order to stop the scan when the trailing edge position matches the second conveyor position; and
generate the three-dimensional image of the object based on the data acquired during the scan.

20. The scanning system of claim 16, wherein said acquisition controller is further configured to:
receive conveyor position data from said conveyor controller;
receive the leading edge position and the trailing edge position from said motion controller;
compare each of the leading edge position and the trailing edge position with a respective first conveyor position and second conveyor position, the first conveyor position corresponding to a first distance between said sensor and the start of the scan range, the second conveyor position corresponding to a second distance between said sensor and the end of the scan range;
perform the scan of the object to acquire raw data using said scan controller when the leading edge position matches the first conveyor position;
issue the halt command to said scan controller in order to stop the scan when the trailing edge position matches the second conveyor position; and
generate the three-dimensional image of the object based on the data acquired during the scan.
